(19) United States
(12) Patent Application Publication
(10) Pub. No.: US 2018/0342883 A1
(43) Pub. Date: Nov. 29, 2018

(54) BATTERY CHARGER WITH DETACHABLE BATTERY

(71) Applicants: Mathew Inskeep, Highland Beach, FL (US); Ling To Shum, Boca Raton, FL (US)

(72) Inventors: Mathew Inskeep, Highland Beach, FL (US); Ling To Shum, Boca Raton, FL (US)

(73) Assignee: Vector Products, Inc., Boca Raton, FL (US)

(21) Appl. No.: 15/984,789

(22) Filed: May 21, 2018

Related U.S. Application Data
(60) Provisional application No. 62/510,846, filed on May 25, 2017.

(51) Int. Cl. H02J 7/00; B60L 11/18; H01M 10/44

(52) U.S. Cl. CPC H02J 7/0027; H01M 10/441; B60L 11/185

(57) ABSTRACT

A compact portable battery charger coupled with a detachable tool battery or similar external source that enables a convenient portable method to recharge or provide a boost to a secondary depleted battery such as that of a combustion engine. The portable battery charger apparatus incorporates a method of extracting energy from a tool battery pack, or the like to fast charge a secondary battery. The secondary battery could be of various electrical and physical size. The extracted energy is transferred to the secondary battery connected to the output of the charger using a high efficiency DC-to-DC switching regulator.

This application claims priority to and the benefit of U.S. Application Ser. No. 62/510,846, filed May 25, 2017, which application is incorporated by reference in its entirety for all purposes.

### FIELD OF THE DISCLOSURE

The disclosure relates generally to battery chargers and more particularly to compact and portable vehicle battery charger system.

### BACKGROUND OF THE DISCLOSURE

Traditionally, battery charger systems with engine start or battery boost capability are powered using home alternating current (AC) power. Other battery charger systems operate from an internal lithium battery and provide a sudden boost of energy.

Power tool battery packs are readily available and in great demand in the industry of hand held power tools. Thus far, battery packs are used in the industry to operate tools such as screwdrivers, impact wrenches, vacuums, blowers, etc. by providing energy to an associated power tool. Due to its internal design and constructions, a power tool battery is limited for the maximum energy that it can deliver in a short period of time or instantaneously. There are several systems in the market that over exceed their internal battery capacity causing an unsafe condition to the end user with the potential results of an explosion due to over exceeding battery capabilities and/or drastically reducing the life cycle of the battery pack. There currently exists a need for using the energy inside a tool battery pack for other purposes, such as, but not limited to, incorporation into a battery charger system for fast charging secondary batteries.

The novel devices disclosed in the below current disclosure are directed to this current need, while also superseding other existing systems and solving previous issues, such as, but not limited to, in the areas of safe, portability, and limited area usage including, without limitation, those found with outdoor hand-held tools.

Additionally, existing devices are available on the marks that utilizes high frequency battery chargers to recharge secondary batteries. However, these existing devices require direct connection to household type electricity. The novel devices disclosed below also overcome this limitation of needing direct connection to a household electricity source found with existing devices.

### SUMMARY OF THE DISCLOSURE

A novel system and method is disclosed for using the energy of a tool battery pack or similar power source, such as, without limitation, a sealed lead acid (SLA) or lithium ion (Li-Ion) chemistry and transferring the internal energy from the tool battery pack into a depleted secondary battery preferably using a relatively fast switching regulator, such as a high frequency battery charger as the link. A high frequency battery charger topology can be used to expand the use of a tool battery pack with a preferred non-limiting goal for a fast charge of a depleted battery to start a combustion vehicle engine

The disclosed system and method does not require any connection to a AC power source, nor does it require a direct tap into the energy of a lithium battery. The disclosed system also provides enhanced safety as compared to preexisting systems by limiting the charging current from the tool pack into the secondary battery. In one non-limiting embodiment, limiting the charging current can occur by coding a safety margin into the algorithm of the system software so that the charging current is prevented from exceeding the maximum discharging current of the tool pack. Another non-limiting safety margin can be to tap into the integral temperature sensor of the tool battery and have the system monitor it for any temperature rise beyond the manufacturers specifications, thus, helping to reduce, if not prevent, catastrophic failures.

Preferably, the disclosed novel system is a compact and portable vehicle battery charger system. Two non-limiting novel features of the system, include, (1) when the charger system is coupled with a detachable tool battery or similar external source it will enable portability to the end-user to conveniently recharge a secondary battery, such as, those used in the electrical system of combustion engines, without the need for connecting to a household type power source; and (2) the system can expand the usage of a tool battery outside its own intended purpose.

Use of the novel system allows for the integration of a tool battery into the automotive industry. In one non-limiting embodiment, this can be accomplished by providing a receptacle docking station into the body of the system to accommodate the tool battery, in conjunction with a DC-to-DC switching regulator type battery charger.

Additional features for the disclosed novel system can include an alternator check, recharging port, LED lights, USB port and/or battery diagnosis.

The system and method provide for the safe operation and coupling of a tool battery for use in the automotive industry. The tool battery pack can be connected to the system in one non-limiting embodiment by mechanically and electrically coupling the tool battery pack to a docking compartment of the external enclosure of the novel system/device. Preferably, the tool battery pack is fully recharged/charged prior to coupling. Upon connection, the internal memory and microprocessor of the novel system/device can be activated and ready for user interface, preferably with external visual indication through the use of a liquid crystal display screen or other screen type or visual indicator. The microprocessor can automatically monitor and maintain the battery tool pack operating at optimum capacity without exceeding the manufacturer's maximum rating during each discharge cycle occurring during the charging mode of a secondary battery. Whenever the tool battery becomes discharged or is otherwise operating under a potentially hazardous scenario, the microprocessor can automatically stop all operations and display to the user that the tool battery is in need of recharge or other appropriate attention. Additionally, the microprocessor can actively and automatically monitor any temperature rise of the tool battery pack. Thus, the novel system/device provides for the safe operation of the tool battery pack when in use in a different environment, such as, but not limited to, automotive industry.

Accordingly, the disclosed novel system/device and method provides for a portable, compact and efficient way to use a tool battery as a battery charger for secondary batteries, such as, but not limited to, a combustion engine battery charger, thus, allowing to expand its usage beyond its original intended use. The system and method integrate two electrical systems to supplement overall performance and usefulness to the end user. In the preferred embodiment, the novel system is coupled with a tool battery and expands the usage of the tool battery outside its original intended purpose.

### BRIEF DESCRIPTION OF THE DRAWINGS

FIG. 1 is a perspective view of one non-limiting embodiment for the main components of the system in accordance with the present disclosure, with it being understood that the type enclosure used is not considered limited to any particular enclosure and may change depending on the type of tool battery pack and all types, shapes, materials, dimensions, etc. can be used for the enclosure and are considered within the scope of the disclosure;

FIG. 2 illustrates an internal electrical flow and block diagram for one non-limiting embodiment of the novel system in accordance with the present disclosure and showing the main components of the system, transmission lines, and data flow;

FIG. 3 illustrates one non-limiting docking compartment for the battery tool pack, including a non-limiting representation of the battery connections;

FIG. 4 illustrates a non-limiting flowchart of the process flow when providing a boost to or charging the external depleted battery in accordance with the present disclosure

FIG. 5 illustrates a non-limiting flowchart of the process flow for conditional LED lighting on an information display in accordance with the present disclosure;

FIG. 6 illustrates a non-limiting flowchart of the process flow for use of the USB in accordance with the present disclosure; and

FIGS. 7, 8, 9, 10 and 11 illustrates an alternative non-limiting housing/enclosure for the novel system, with FIG. 8 also showing a non-limiting battery pack disposed within the docking bay/cradle.

### DETAILED DESCRIPTION

As seen in the drawings, a novel system and method is provided for using the energy of a tool battery pack or similar power source. The tool battery back/power source can be preferably sealed lead acid (SLA) or lithium ion (Li-Ion) chemistry. The novel system/device (collectively “system”) and method transfers the internal energy from the tool battery pack into a depleted secondary battery. In one non-limiting embodiment, a switching regulator high frequency battery charger can be preferably used as the link between the tool battery pack and the secondary battery. Thus, the system preferably includes using a high frequency battery charger to expand the use of a tool battery pack. In one non-limiting use, a fast charge of a depleted battery is achieved in order to start a combustion engine associated with the depleted battery.

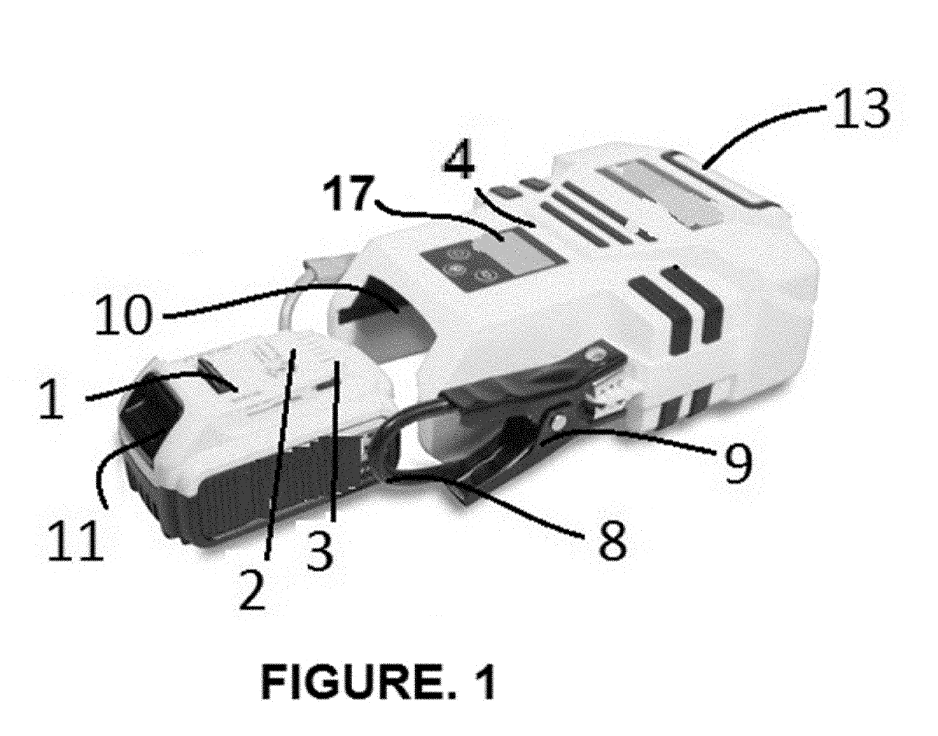

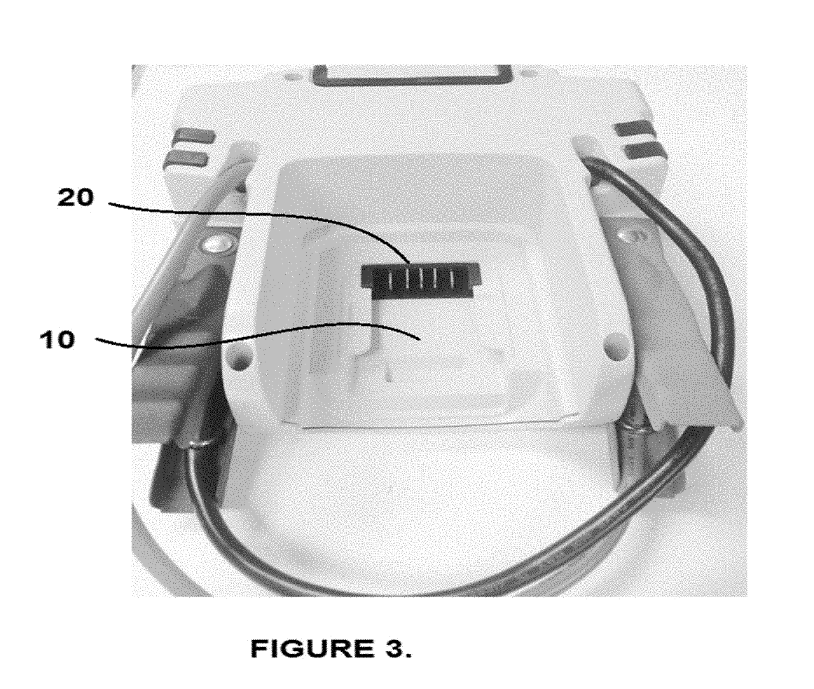

When using the system with a tool battery back, preferably the user initially verifies that a proper connection has been successfully established between the tool battery pack and the system. FIG. 1 is a representation of one non-limiting embodiment for the disclosed system from an external viewpoint. As seen, a main body enclosure 13 is provided and not considered limited to any particular shape, dimensions, materials or size. Additionally, as noted above, main body enclosure 13 may change without altering or affecting the electrical characteristic of the described system. Main body enclosure 13 can be constructed so it can accommodate different styles for a tool battery pack 1 presently available on the market or later developed. Tool battery pack 1 is provided with one or more, and preferably a plurality of, components that can be coupled mechanically and electrically with the described system. Tool battery pack 1 preferably can be provided with a mechanical latch 11 for locking and releasing when attaching tool battery pack 1 to a docking bay 10 on main body enclosure 13. As seen in FIG. 3, docking bay 10 provides a cradle like support to safely retain tool battery pack 1 in addition to providing an internal electrical interconnect 20 mating receptacle between tool battery pack 1 and body enclosure 13.

Tool battery pack 1 integrates energy electrical conductor path 2 and 3 that will interconnect with the proper matching polarity (voltage potential) integrated in the body of the docking bay 10 and can also include additional access to a battery pack internal temperature sensor. A recharging port 23 can also be provided for charging battery pack 1.

The voltage and mechanical features for tool battery pack 1 may vary depending on the manufacturer and all variations are considered within the scope of the disclosure. The voltage of tool battery pack 1 may also differ by manufacturer and the incoming voltage potential (VI) 7 can be lower or higher than that of the voltage output (VO) 6 of a DC-to-DC switching regulator circuit 4. Further, in a preferred embodiment the system can contain a pair of high energy battery clips 9 and a pair of electrical conductors 8, which allow a direct connection to an external load. In a preferred use the external load can be a depleted battery 16 and tool battery pack 1 preferably transfers its energy at a fast rate of charge to depleted battery 16 via DC-to-DC switching regulator 4, output switch 18, and output conductors 8 and clamps 9.

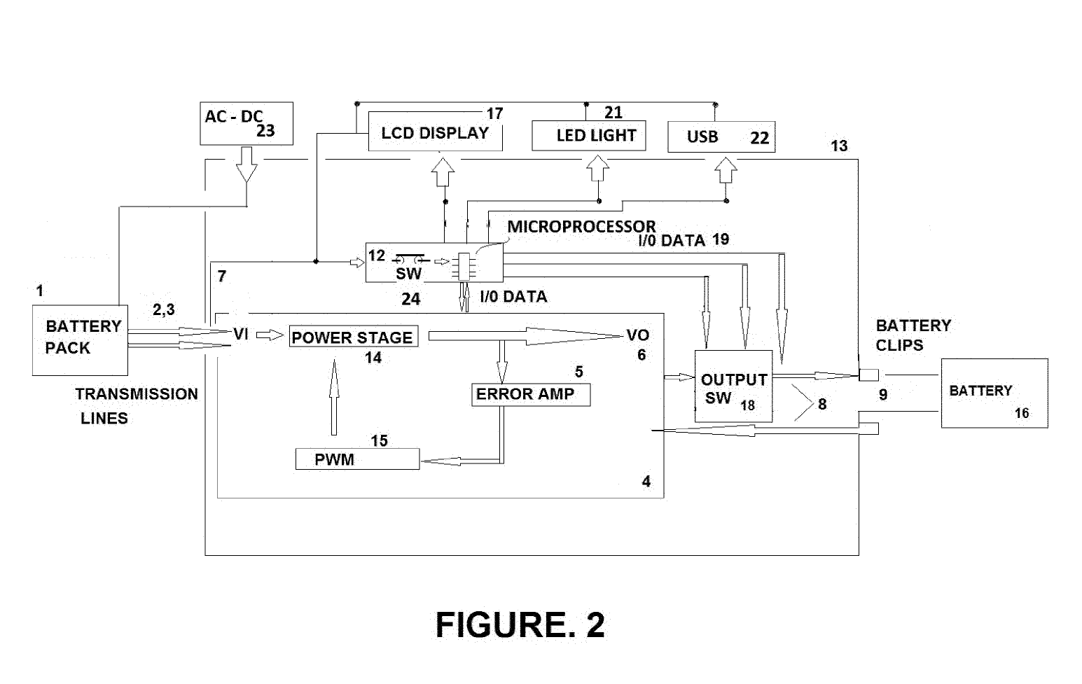

FIG. 2 depicts a non-limiting high level electrical block diagram of the internal components of the disclosed novel system. Tool battery pack 1 can be of various chemistry and various manufacturers with various configurations and sizes, without affecting the desired outcome from using the disclosed novel system and method. Tool battery pack 1 preferably contains a pair of electrical conductors 2, 3. Upon insertion of tool battery pack 1 into docking bay 10 of main body enclosure 13 electrical conductors 2,3 connect to or into DC-to-DC switching regulator circuit 4. Internal microprocessor 12 is programmed to control operation of switching regular circuit 4, as well as the general operation of the disclosed system and method. With tool battery back 1 properly connected within docking bay 10, a signal can be provided to microprocessor 12 which causes microprocessor 12 to run a diagnostic of tool battery pack 1. The diagnostic generally checks the health of battery pack 1 and can guide the user whether or not tool battery pack 1 has sufficient energy to engage an external load 16 or whether recharging of tool battery pack 1 is necessary prior to commencing the charging sequence for charging external load 16. Any diagnostic results can be related to or displayed by a LCD display 17 on the main body enclosure 13. Preferably, the boost system is connected to the depleted battery during the diagnostics.

In addition to confirming a proper connection for tool battery pack 1 within docking bay 10, the system also checks and/or confirms that an output load 16 is also properly connected, prior to engaging the charging process. As part of this checking/confirmation, microprocessor 12 can run a diagnostic of output load 16 via I/O data lines 19. Preferably, microprocessor checks the condition of whether a proper connection exist between the external load 16 and battery clamps or clips 9 (collectively “clamps”) and if a proper connection exist, output switch 18 makes a direct connection to load 16. Any diagnostic results can be related to the LCD display 17 on the main body enclosure 13.

Preferably, once all of the above-described input and output diagnostics are run, microprocessor 12 engages DC-to-DC switching regulator circuit 4 and the charging process begins. Though the initial checks/diagnostics are optional, they are preferred, as they provide a form of safety when using the disclosed novel system and method.

Referring to FIG. 2, and in particular the internal components that preferably make up circuit 4, which can be a power stage 14, a pulse width modulator 15 and an error amplifier 5 circuit and can be responsible for delivering the energy from battery pack 1 to the external battery 16. These preferred components for circuit 4 can be adjusted to receive from the battery pack 1 various dc voltages, preferably as low as six (6V) volts and preferably up and as high as sixty (60V) volts. As such, circuit 4 can regulate the DC signal coming in from battery pack 1 and preferably either steps up this incoming DC signal or steps down this DC signal to match that of external battery 16. Circuit 4 outputs its DC signal to match that of the external battery 16.

In one non-limiting embodiment the regulating of the DC signal coming from battery pack 1 can be This is achieved by the following process: Internal battery pack 1 is electrically connected to microprocessor 12 and is also connected to power stage circuit 14. First, microprocessor 12 reads the incoming DC signal from the battery pack 1. Then microprocessor 12 determines if the incoming DC signal from battery pack 1 matches, is lower than, or exceeds the voltage of external battery 16. If the voltage from battery pack 1 and external battery 16 are a match, then circuit 4 operating in unity with the internal components 14, 15 and 5 will regulate the incoming DC signal from the battery pack 1 to keep the output voltage VO6 to the external battery 16 at the ideal level to match external battery 16 manufacturer's recommended charging voltage range. As a non-limiting example: if microprocessor 12 reads an incoming voltage from external battery 16 and it's a twelve (12V) volt system, circuit 4 will maintain appropriate levels for a twelve (12V) volt system. Similarly, if microprocessor 12 determines external battery 16 is a twenty-four (24V) volt system, then circuit 4 will match the signal require to charge external battery 16, independent of DC voltage of battery pack 1.

Preferably, microprocessor 12, under normal operation can send a series of continuous logic pulses (i.e. square waveform is symmetrical in shape and has a positive pulse width equal to its negative pulse) to pulse width modulator 15. This series of pulses determines the output on and off duty cycle frequency of PWM 15 circuit to the power stage 14. PWM circuit 15 sends the signals received from microprocessor 12 to power stage 14. This duty cycle frequency waveform is delivered to power stage 14 circuit, which can be made up power MOSFET(s) and on other discrete electrical components, and the energy transfers begins. The speed and amount of the energy transfers can be determined by the logic pulses speed and amplitude and it can be continuously corrected by error amplifier circuit 5. Error amplifier 5 dynamically takes voltage samples of the output VO6 current. This sample is compared to a pre-determined reference voltage. If the samples voltage is lower or higher than that of the pre-determine reference voltage, the error amplifier 5 task is to correct for any gain or loss from the sample voltage collected. The error amplifier preferably can have two input signals, one can be a reference voltage and the second signal can be the incoming signal from the power stage. During the boost function, the error amplifiers samples the signal out of the power stage and compares it to an already pre-defined reference voltage. The error amplifier tries to maintain the incoming signal from the power stage output as close as possible to the reference signal and corrects for any error signal. The output of the error amplifier is then sent to the pulse width modulator for final adjustment and correction and loops continuous.

Thus, power stage 14 can essentially be a digital switch (ON/OFF) that closes and opens at the speed demanded by the incoming pulses from the PWM 15 circuit, in order to maintain a stable output voltage VO 6. Accordingly, the components of circuit 4 working in unity provide for a DC-to-DC switching current regulator that draws energy from tool battery 1 through transmission lines 2 and 3, which enter as a level DC potential signal and outputs the appropriate DC level potential via output switch 18 and battery clips 9.

The construction of output switch 18 can be mechanical, electro-mechanical or electronic solid state. If the switch is mechanical a manual activation can be allowed. Where the switch is either electro-mechanical or electronic, it can become active when an appropriate logic signal is sent by onboard microprocessor 12 through an input/output (I/O) data lines 19 to output switch device 18 resulting in the closure of switch 18.

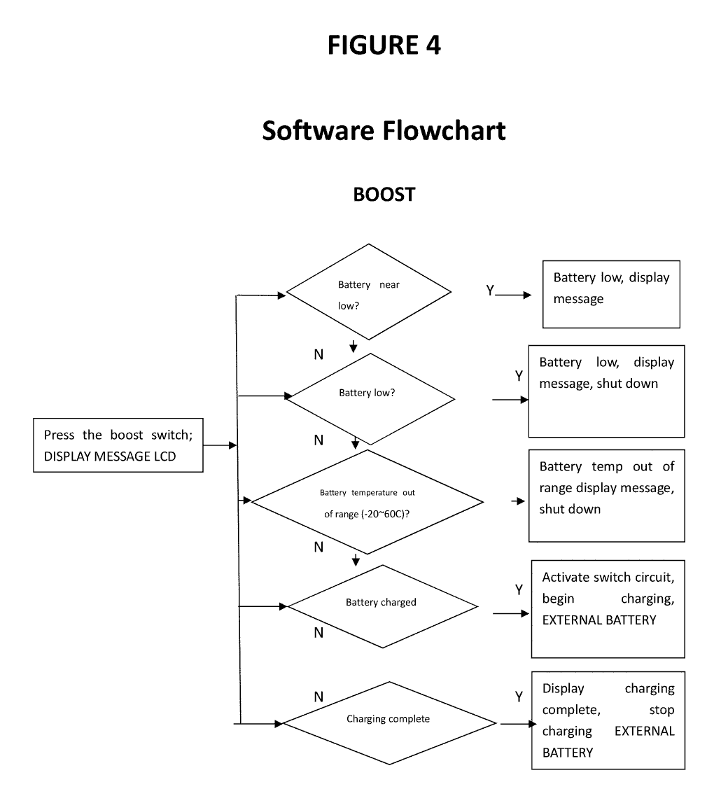

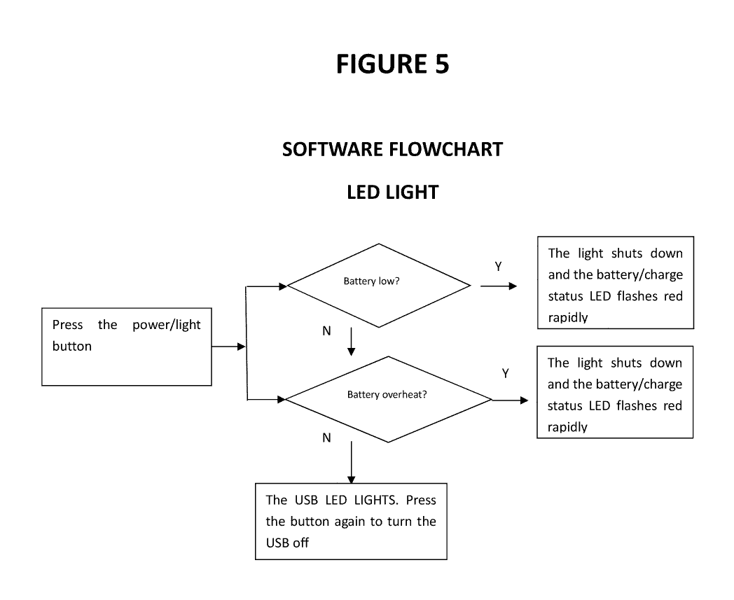

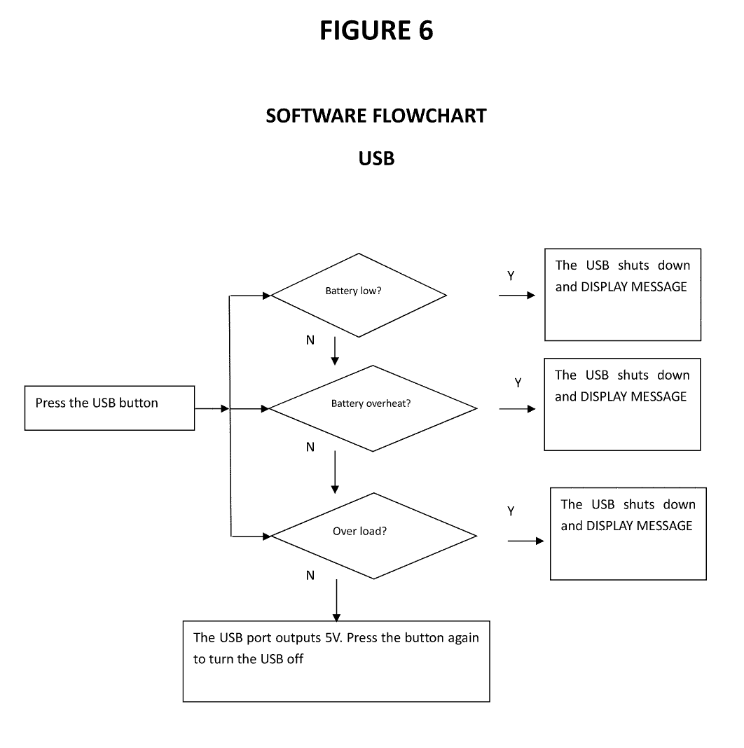

FIGS. 4 through 6 illustrates software flow charts for certain novel algorithms performed, involving or controlled by microprocessor 12. In certain uses, some user interface can be incorporated to active at least some of the features provided by the novel device. As such, a tactile or momentary switch(s) 20 can be utilized to send logic signals to microprocessor 12 to start a task and/or power an LCD display 17. In certain non-limiting embodiments, an LED area light 21 can be provided for illumination and/or a USB charging port 22/23 to charge small electronic devices.

Despite these additional features, the primary task of the disclosed novel device is to provide a fast DC charging (boost) current to a depleted battery 16. This primary task can be initially activated when the user presses the tactile or momentary switch(s) on a control panel. After the switch(s) cycle ON/OFF, microprocessor 12 can activate all the necessary logic signals, as previously described, and the fast DC charging (boost) current can commence.

Certain non-limiting features of the above disclosed novel system and method can include:
1. A power tool battery pack with a wide nominal voltage.
2. A power tool battery pack coupled with an integrated DC-DC switching regulator and a high output power switch to provide jump start assistance to a depleted system.
3. The high output power switch can be a mechanical, electro-mechanical or electronic solid-state device.

Non-limiting descriptions for the reference numbers seen in the figures can include:

| | |
|---|---|
| 1. Tool battery pack | 2. 1^{st} Tool battery pack electrical conductor |
| 3. 2^{nd} Tool battery pack electrical conductor | 4. DC to DC switching regulator |
| 5. Error feedback amplifier | 6. Switching Regulator Output |
| 7. Voltage Input | 8. Energy output electrical conductors |
| 9. Battery clips | 10. Docking bay |
| 11. Tool battery release lock latch | 12. Microprocessor and controls |
| 13. Main body enclosure representation | 14. Power stage |
| 16. Load/External Battery | 17. LCD display |
| 18. Output switch | 19. Output I/O lines |
| 20. Docking compartment receptacle | 15. Pulse Width Modulator Circuit |
| 21. LED light | 22. USB receptacle |
| 23. Charging port | 24. Tactile switch(s) |

Accordingly, integrating a tool battery into the automotive industry can be accomplished by coupling the tool battery to a DC-to-DC switch regulator to conveniently recharge a secondary battery, without the need to connecting to a household type power source. The DC-to-DC switching regulator converter circuit can be adapted for electrical communication with a tool battery pack and capable of extracting the energy from the battery pack. The DC to DC switching regulator can be controlled by a microprocessor dynamically adjusting the duty cycle to maintain a constant output current and/or while monitoring the tool battery pack internal temperature sensor operation. In one non-limiting embodiment, the DC-to-DC switching regulator can include a high frequency pulse width modulator, error amplifier and power stage. In one non-limiting embodiment, the DC-to-DC switching regulator circuit can be electrically coupled with the tool battery pack through a pair of electrical contacts.

The microprocessor can run diagnostic on the tool battery pack and provide/relay/display external messages to user via visual or audible signals.

A safety power switch mechanical, electro-mechanical or electronic solid-state device can also be included. The safety switch can be a high-power switch in electrical communication with an output line of the single cell, to charge the load device when the switch is closed.

The load device or secondary battery can be a dead battery of a motor vehicle. The load device can be electrically connected to the DC-to-DC switch regulator through output transmission lines and a pair of clips. A first battery clip can be connected to a first output transmission line and a second battery clip can be connected to a second output transmission line. The safety switch can be disposed between and in electrical communication with the DC-to-DC switch regulator and the secondary battery. The charged single cell (tool battery) is permitted to charge the load device or assist in starting a motor vehicle having a depleted battery when the switch is closed.

In a preferred embodiment, the battery pack is of a type of battery pack used to power a portable power tool.

The disclosed device can be used for obtaining electrical energy from a power source for using the obtained energy in aiding in starting of a motor vehicle whose vehicle battery has been depleted to an energy level where the vehicle battery is unusable for an intended purpose of starting the vehicle on its own. During use, the following non-limiting steps can be performed:

(a) at least a portion of the energy is extracted from the battery pack;

(b) the specific DC voltage potential level of the extracted reserve energy is boosted up or stepped down to a higher or lower DC voltage potential level; and

(c) a load battery is charged using the extracted energy from the tool battery pack.

In addition to charging the load battery or alternatively to charging, the electrical energy stored in the charged single cell can be used to assist in turning over an engine of a motor vehicle whose vehicle battery that is depleted to a point where it cannot turn over the engine on its own. Thus, the charged single cell can be used to charge a previously depleted vehicle battery to a level where the vehicle battery is capable of being used for the intended purpose of the battery.

As previously mentioned a boost or step up converter circuit is electrically connected to the battery to extract the energy from the battery pack and either boosting up or stepping down the DC voltage potential level. The timing of using the boosted circuit when charging the single cell or capacitor bank can also be regulated. Also, the timing of using the extracted energy can be regulated and the amount of current that is provided when charging the load battery can be regulated or restricted.

As part of the use of the device a switch in electrical communication with an output line of the single cell can also be closed prior to charge the load device with the electrical energy stored by the tool battery.

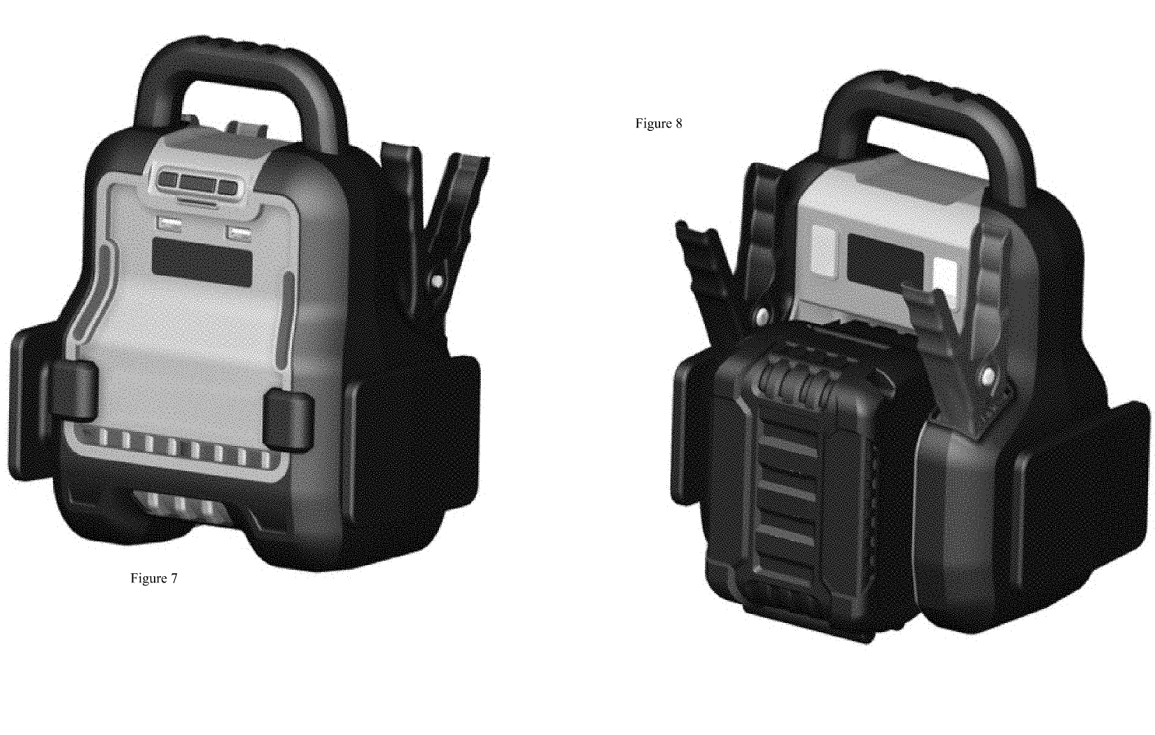

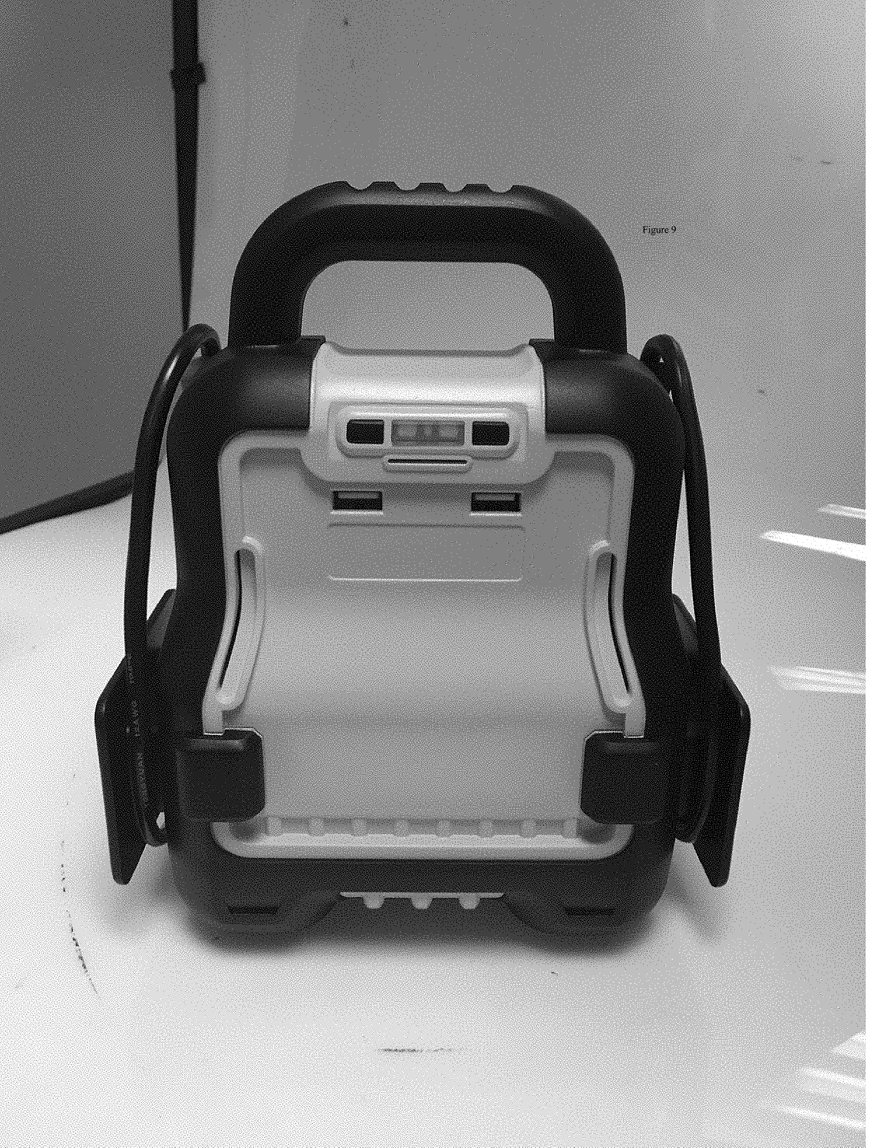

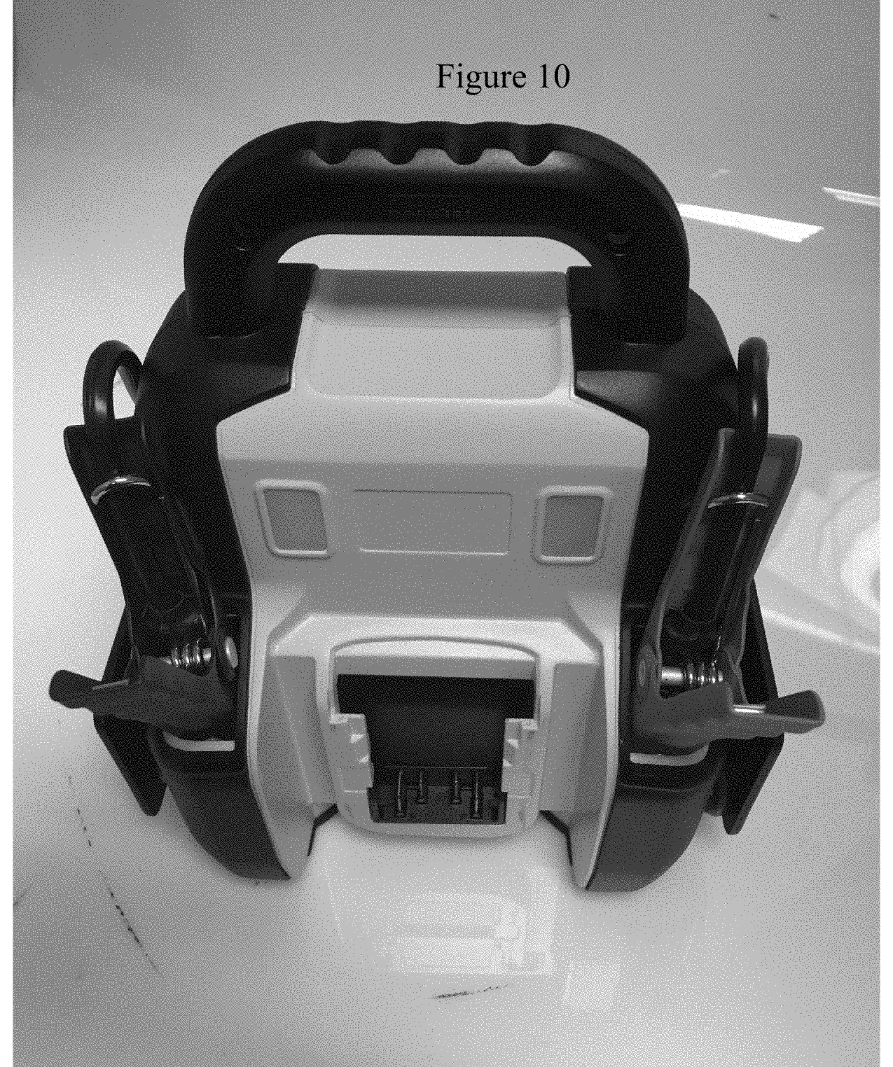

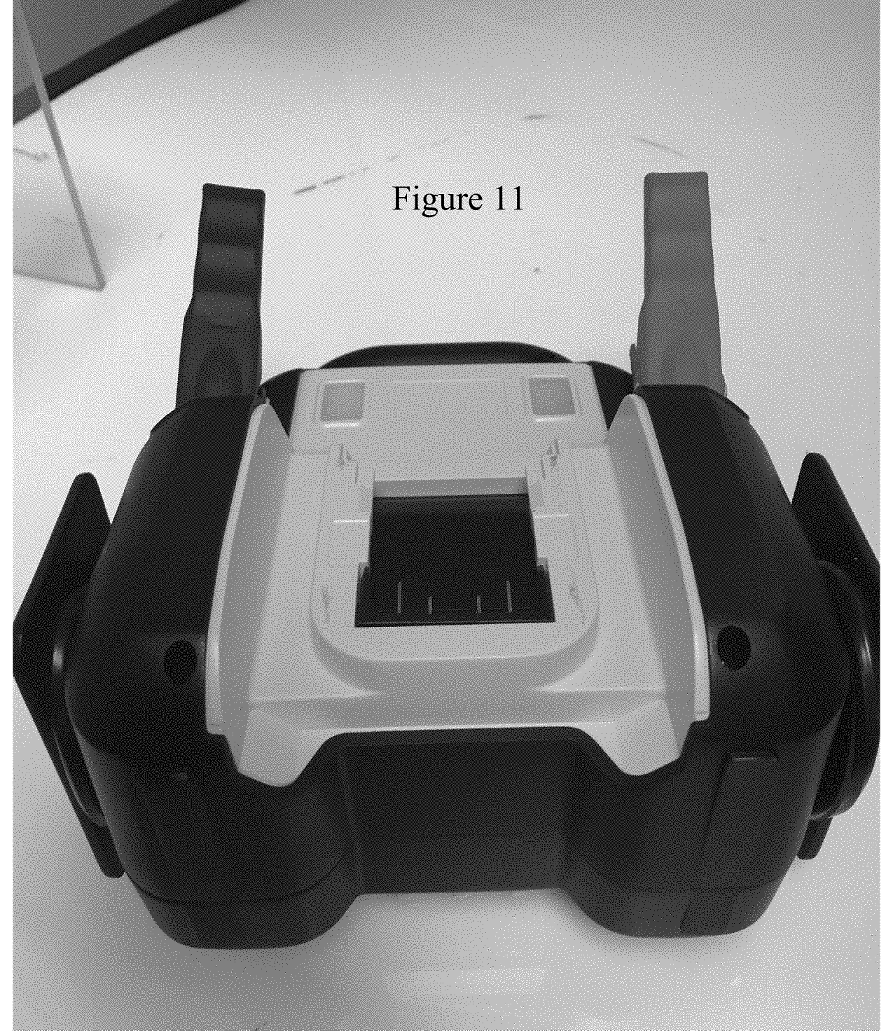

An alternative non-limiting housing for the disclosed novel system/device is shown in FIGS. 7 through 11. Other housing shapes can also be used and all are considered within the scope of the disclosure.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the described device/system and their locations, electronic communication methods between the system components, wiring, attachment or securement mechanisms, dimensions, values, shapes, materials, sensors, monitoring methods, etc. discussed above or shown in the drawings, if any, are merely by way of example and are not considered limiting and other component(s) and their locations, electronic communication methods, wiring, attachment or securement mechanisms, dimensions, values, shapes, materials, sensors, monitoring methods, etc. can be chosen and used and all are considered within the scope of the disclosure.

The benefits, advantages, solutions to problems, and any element(s) that may cause any benefit, advantage, or solution to occur or become more pronounced are not to be construed as a critical, required, or essential features or elements of any or all the claims.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

While the novel system and method have been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A system for providing a boost of energy to or to charge a depleted external load using a battery pack, comprising:
a body enclosure having a docking bay, the docking bay adapted for receipt of a battery pack; and
a DC-to-DC switching regulator in electrical communication with a pair of electrical conductors of the battery pack when the battery pack is received within the docking bay, the DC-to-DC switching regulator adapted for electrical communication with the depleted external load when the system provides the boost of energy.

2. The system for providing a boost of energy of claim 1 further comprising a microprocessor disposed within the body enclosure and programmed to control the operation of the DC-to-DC switching regulator.

3. The system for providing a boost of energy of claim 1 further comprising an internal electrical connector disposed within the body enclosure and externally accessible at the docking bay, the internal electrical connector adapted for electrical communication with the pair of electrical conductors when the battery pack is received within the docking bay, the internal electrical connector electrically connected to DC-to-DC switching regulator in order to provide electrical communication between the electrical conductors and the DC-to-DC switching regulator.

4. The system for providing a boost of energy of claim 2 wherein the microprocessor in electrical communication with the electrical conductors of the battery pack and programmed to run a diagnostic of the battery pack received within the docking bay prior to allowing the DC-to-DC switching regulator to receive energy from the battery pack.

5. The system for providing a boost of energy of claim 1 wherein the external load is a vehicle battery and the boost of energy allows the vehicle battery to be used to start a combustion vehicle engine.

6. The system for providing a boost of energy of claim 2 further comprising a visual display for displaying information to a user regarding the tool battery pack or charging or transferring of energy process, the information displayed by the visual display received from the microprocessor.

7. The system for providing a boost of energy of claim 2 further comprising a pair of battery clamps or clips (clips”) and a pair of output electrical conductors, each of the output electrical conductors in electrical communication with the DC-to-DC switching regulator; each of the pair of battery clips secured to an end of a specific one of the pair output electrical conductors, each of the pair of battery clips adapted for securement to a specific terminal of the external load; wherein the microprocessor receiving information regarding the securement of the pair of battery clips to the pair of terminals and programmed to run a diagnostic to determine if each clip is attached to a correct terminal of the external load.

8. The system for providing a boost of energy of claim 7 further comprising a switch included with one of the output electrical conductors and the microprocessor is programmed to close the switch when the microprocessor determines that a proper securement exist between the pair of battery clips and the pair of terminals of the external load.

9. The system for providing a boost of energy of claim 1 wherein the battery pack is a battery pack used for a power tool.

10. The system for providing a boost of energy of claim 2 wherein the microprocessor programmed to regulate a DC signal received from the battery pack such that the received DC signal matches a voltage and is in a recommended charging voltage range of the depleted external load.

11. A system for providing a boost of energy to or to charge a depleted external load using a battery pack, comprising:
a body enclosure having a docking bay, the docking bay adapted for receipt of a battery pack; a DC-to-DC switching regulator in electrical communication with a pair of electrical conductors of the tool battery pack when the battery pack is received within the docking bay, the DC-to-DC switch regulator adapted for electrical communication with the depleted external load when the system provides the boost of energy
a microprocessor disposed within the body enclosure and programmed to control the operation of the DC-to-DC switching regulator, the microprocessor in electrical communication with the electrical conductors of the battery pack and programmed to run a diagnostic of the battery pack received within the docking bay prior to allowing the DC-to-DC switching regulator to receive energy from the battery pack, the microprocessor programmed to regulate a DC signal received from the battery pack such that the received DC signal matches a voltage and is in a recommended charging voltage range of the depleted external load;
a pair of battery clamps or clips (clips”), each of the pair of battery clips adapted for securement to a specific terminal of the external load; and
a pair of output electrical conductors, each of the output electrical conductors in electrical communication with the DC-to-DC switching regulator; each of the pair of battery clips secured to an end of a specific one of the pair output electrical conductors;
wherein the microprocessor receiving information regarding the securement of the pair of battery clips to the pair of terminals and programmed to run a diagnostic to determine if each clip is attached to a correct terminal of the external load.

12. The system for providing a boost of energy of claim 11 further comprising a visual display for displaying information to a user regarding the tool battery pack or charging or transferring of energy process, the information displayed by the visual display received from the microprocessor.

13. The system for providing a boost of energy of claim 11 further comprising a switch included with one of the output electrical conductors and the microprocessor is programmed to close the switch when the microprocessor determines that a proper securement exist between the pair of battery clips and the pair of terminals of the external load.

14. A method for providing a boost of energy to or to charge a depleted external load using a tool battery pack
a. receiving a tool battery back by a docking bay of an energy boost system;
b. transferring energy from the tool battery pack to a depleted external load through the energy boost system.

15. The method for providing a boost of energy of claim 14 further comprising the step of running a diagnostic of the tool battery pack by a microprocessor of the energy boost system prior to transferring energy from the tool battery pack in step b.

16. The method for providing a boost of energy of claim 15 further comprising the step of recharging the tool battery pack where the microprocessor determines from the diagnostic that the tool battery pack needs to be recharged prior to transferring energy from the tool battery pack in step b.

17. The method for providing a boost of energy of claim 14 further comprising the step of connecting a pair of battery clips of the energy boost system to a pair of terminals of the depleted external load and running a diagnostic of the connection to determine if the connection is correct by a microprocessor of the energy boost system prior to transferring energy from the tool battery pack in step b.

18. The method for providing a boost of energy of claim 17 further comprising the step of closing an electrical switch in one of a pair of output electrical conductors of the energy boost system where the microprocessor determines that a proper connection exist between the battery clips and the terminals.

19. The method for providing a boost of energy of claim 14 wherein step b. comprises the steps of engaging a DC-to-DC switching regulator circuit by a microprocessor to cause energy to transfer from the tool battery pack to the external load, the DC-to-DC switching regulator in electrical communication or connection with the tool battery pack and the depleted external load.

20. The method for providing a boost of energy of claim 14 further comprising the step of regulating a DC signal received from the tool battery pack to match a voltage of the depleted external load prior to transferring the energy from the tool battery pack to the depleted external load.

21. The method for providing a boost of energy of claim 14 further comprising the step of regulating an incoming DC signal received from the tool battery pack to a match a recommended charging voltage range for the depleted external load.
